(19) United States
(12) Patent Application Publication
(10) Pub. No.: US 2026/0046699 A1
(43) Pub. Date: Feb. 12, 2026

(54) METHODS AND SYSTEMS FOR COORDINATION OF ENERGY AWARE POLICIES WITH TRAFFIC INFLUENCE BETWEEN APPLICATION FUNCTION AND POLICY CONTROL FUNCTION

(71) Applicant: InterDigital Patent Holdings, Inc., Wilmington, DE (US)

(72) Inventors: Achref Methenni, Montreal (CA); Saad Ahmad, Montreal (CA); Samir Ferdi, Kirkland (CA); Ulises Olvera-Hernandez, Saint-Lazare (CA); Michael Starsinic, Newtown, PA (US)

(21) Appl. No.: 18/798,560

(22) Filed: Aug. 8, 2024

(51) Int. Cl. H04W 28/18; H04L 45/12; H04W 28/08

(52) U.S. Cl. CPC H04W 28/18; H04L 45/124; H04W 28/0925

(57) ABSTRACT

A method is provided in connection with routing traffic in a Protocol Data Unit (PDU) session of a wireless network. The method involves a Policy Control Function (PCF) receiving a request to influence traffic routing, determining to request energy cost information based on the request, and transmitting a message to an Energy Efficiency Control Function (EECF). The PCF determines a routing policy based on the received energy cost information and transmits it for use in the PDU session. The energy cost information includes respective energy cost information for each Data Network Access Identifier (DNAI) associated with the PDU session. A system implementing the method comprises circuitry for the PCF and EECF. Another method involves a Session Management Function (SMF) of a wireless network in connection with routing traffic in a PDU session.

### TECHNICAL FIELD

The present disclosure is generally directed to the fields of communications, energy efficiency, energy savings, network data analytics, quality of service (QoS), and traffic routing influence procedures.

### BACKGROUND

TR 23.700-66 is a study on Energy Efficiency and Energy Saving and covers various radio technologies including 2G, 3G, LTE, 5G, and 6G. TS 23.501 outlines system architecture for the 5G System (5GS) and provides procedures and policies that govern operation of the 5GS. TS 23.502 details Stage 2 procedures and Network Function Services for the 5GS architecture. TS 23.503 presents policy and charging control framework for the 5GS.

### SUMMARY

In certain representative embodiments, a process is performed by a policy control function (PCF) of a wireless network in connection with routing traffic in a protocol data unit (PDU) session. For example, the process includes receiving a notification of a request to influence traffic routing for the PDU session. Also, for example, the process includes determining to request energy cost information for the PDU session based at least in part on the notification. Further, for example, the process includes transmitting a message to an energy efficiency control function (EECF) requesting the energy cost information for the PDU session based at least in part on determining to request the energy cost information. In addition, for example, the process includes receiving, in response to the message, the energy cost information for the PDU session. Moreover, for example, the process includes determining a routing policy based at least in part on the energy cost information for the PDU session. Furthermore, for example, the process includes transmitting the routing policy for use in the PDU session.

In certain representative embodiments, a process is performed by a session management function (SMF) of a wireless network in connection with routing traffic in a PDU session. For example, the process includes receiving, from a PCF of a wireless network, a first routing policy for the PDU session. Also, for example, the process includes determining to request energy cost information for the PDU session based at least in part on the notification. Further, for example, the process includes transmitting a message to an EECF requesting the energy cost information for the PDU session based at least in part on determining to request the energy cost information. In addition, for example, the process includes receiving in response to the message, the energy cost information for the PDU session. Moreover, for example, the process includes determining a second routing policy based at least in part on the energy cost information for the PDU session. Furthermore, for example, the process includes transmitting the second routing policy for use in the PDU session.

In certain representative embodiments, a wireless network system comprising circuitry is provided for implementing a PCF and an EECF. For example, the circuitry is to receive a notification of a request to influence traffic routing for a PDU session. Also, for example, the circuitry is to determine to request energy cost information for the PDU session based at least in part on the notification. Further, for example, the circuitry is to transmit a message to the EECF requesting the energy cost information for the PDU session based at least in part on determining to request the energy cost information. In addition, for example, the circuitry is to receive, in response to the message, the energy cost information for the PDU session. Moreover, for example, the circuitry is to determine a routing policy based at least in part on the energy cost information for the PDU session. Furthermore, for example, the circuitry is to transmit the routing policy for use in the PDU session.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a sequence diagram illustrating an example of a procedure to process an application function (AF) to influence traffic routing;

FIG. 3 is a sequence diagram illustrating an example of beginning steps of a procedure using 5GS energy cost information to refine an (e.g., energy-unaware) AF influence request;

FIG. 4 is a sequence diagram illustrating an example of Option 1 intermediate steps of the procedure using 5GS energy cost information to refine the (e.g., energy-unaware) AF influence request;

FIG. 5 is a sequence diagram illustrating an example of Option 2 intermediate steps of the procedure using 5GS energy cost information to refine the (e.g., energy-unaware) AF influence request;

FIG. 6 is a sequence diagram illustrating an example of Option 3 intermediate steps of the procedure using 5GS energy cost information to refine the (e.g., energy-unaware) AF influence request;

FIG. 7 is a sequence diagram illustrating an example of ending steps of the procedure using 5GS energy cost information to refine the (e.g., energy-unaware) AF influence request;

FIG. 8 is a sequence diagram illustrating an example of a procedure in which an energy-unaware AF further negotiates with energy aware 5GS N6 traffic routing related procedures;

FIG. 9 is a process diagram illustrating an example of a procedure performed by a PCF of a wireless network in connection with routing traffic in a PDU session; and

FIG. 10 is a process diagram illustrating an example of a procedure performed by an SMF of a wireless network in connection with routing traffic in a PDU session.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

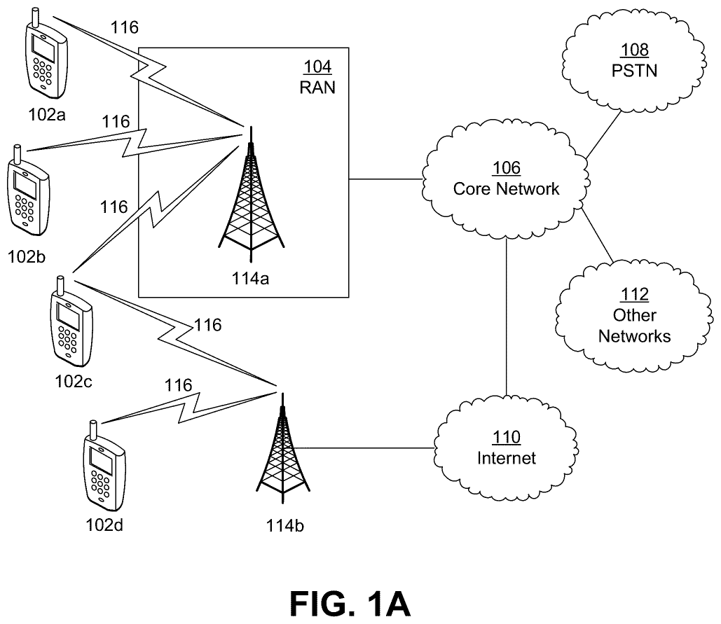

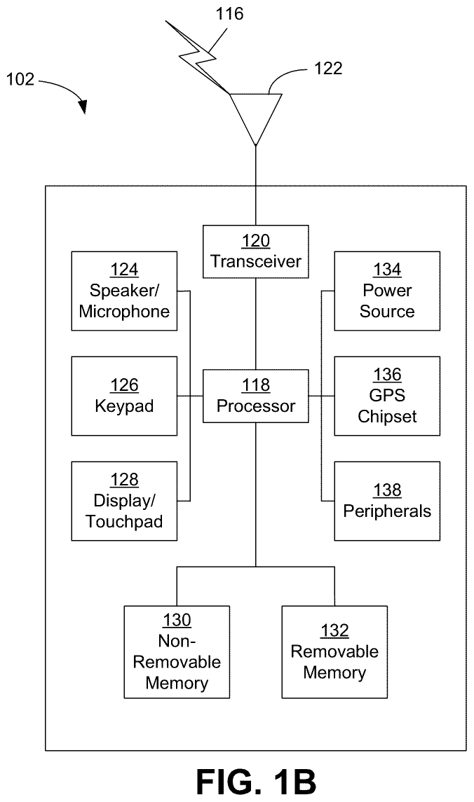

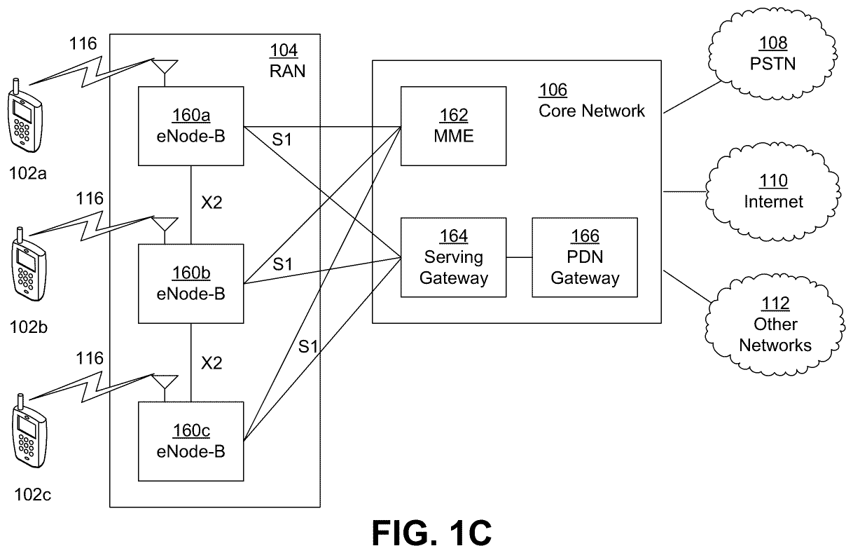

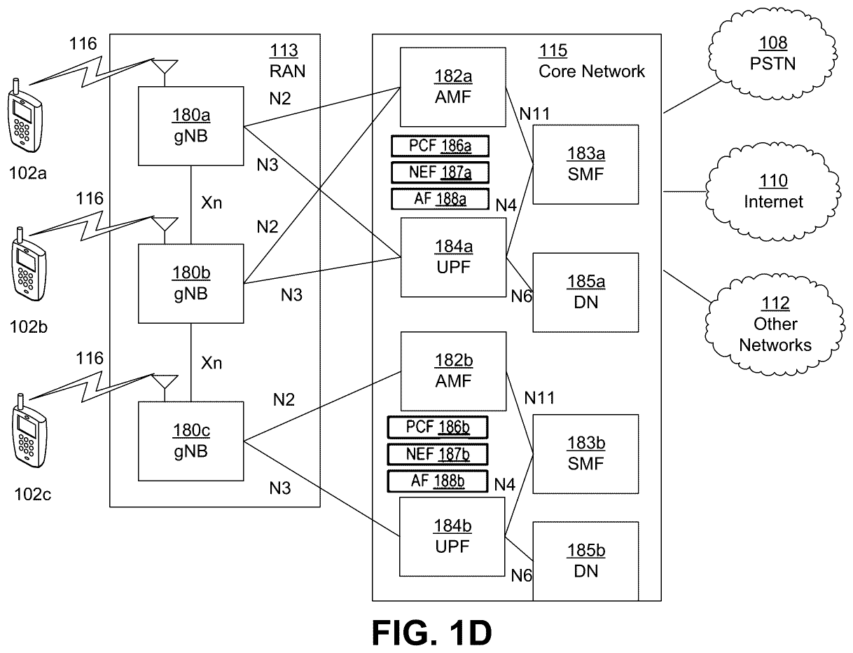

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 06/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in in 802.11 systems. For CSMA/CA, the STAs (e.g., every STA), including the AP, may sense the primary channel. If, for example, the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and a transmitting STA may transmit the data. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if, for example, the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If, for example, the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b, at least one policy control function (PCF) 186a, 186b, at least one network exposure function (NEF) 187a, 187b, and at least one application function (AF) 188a, 188b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

The PCF 186a, 186b can be connected to the AF 188a, 188b in the CN 115 via an N5 interface. The PCF 186a, 186b can be connected to the SMF 183a, 183b in the CN 115 via an N7 interface. The PCF 186a, 186b can be connected to the AMF 182a, 182b in the CN 115 via an N15 interface. The NEF 187a, 187b can be connected to the SMF 183a, 183b in the CN 115 via an N29 interface. The PCF 186a, 186b can be connected to the NEF 187a, 187b in the CN 115 via an N30 interface.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, coordination of energy-aware policies with traffic influence from an AF is provided. For example, an AF that is not aware of network energy aspects (e.g., related to a 5GS and/or one or more user plane (UP) paths) transmits a request for traffic routing influence on the 5GS. Also, for example, a request includes information such as at least one of a list of one or more Data Network Access Identifiers (DNAIs), a WTRU address, N6 related information, combinations of the same, or the like. Further, for example, N6 related information includes at least one of a UP latency requirement, a temporal validity condition, a traffic description, combinations of the same, or the like.

In one example, a 5GS processes an AF request without taking energy-related cost information into consideration. For example, a PCF is triggered to perform one or more energy cost saving procedures. Also, for example, a PCF is triggered to obtain energy cost information related to a list of one or more DNAIs from an EECF. Further, for example, a PCF utilizes obtained energy cost information to determine updated (e.g., N6) routing policies. In addition, for example, an N6 routing policy includes a candidate DNAI list having only one or more DNAIs that provide a desirable energy cost efficiency level. Moreover, for example, a PCF transmits energy information to an SMF.

In another example, during an initial AF request to influence traffic, a PCF and/or an SMF is triggered to obtain energy cost information related to traffic routing. For example, information related to traffic routing is utilized to refine one or more (e.g., N6) routing policies. Also, for example, information related to traffic routing is utilized to perform energy optimal UP path configuration. Further, for example, a 5GS overrides original AF routing information with one or more energy-aware routing policies.

In a further example, a 5GS provides some information, such as a UP path change cause and/or reason value (e.g., “energy cost UP optimization”). For example, a UP path change cause and/or reason value triggers an AF to start a negotiation process with a 5G Core (5GC), e.g., utilizing the PCF. Also, for example, one result of a negotiation includes an AF relaxing certain information. Further, for example, the certain information includes at least one of an update of a UP latency requirement value, allowing relocation of an application, no longer requiring WTRU IP address preservation for a PDU Session, combinations of the same, or the like.

In certain representative embodiments, a PCF is configured to refine and/or update and/or override one or more (e.g., N6) routing policies. For example, one or more routing policies are refined and/or updated and/or overridden based on one or more energy cost-related Key Performance Indicators (KPIs). Also, for example, a PCF is configured to support negotiation with an AF. Further, for example, a PCF is configured to support negotiation with an AF to find a compromise if one or more conflicting conditions are determined and/or detected and/or identified.

In certain representative embodiments, a PCF is configured to perform at least one of: receiving a notification message (e.g., from a Unified Data Repository (UDR)); determining that an AF request impacts one or more PDU sessions; requesting energy cost information; obtaining energy cost information from an EECF; using energy cost information to update one or more (e.g., N6) routing policies; utilizing energy cost information to update one or more (e.g., Policy and Charging Control (PCC)) rules; transmitting one or more PCC rules to an SMF; upon receiving an AF request for (e.g., N6) routing traffic influence, obtaining energy cost information; utilizing energy cost information and initial (e.g., N6) routing information from an AF request to update one or more (e.g., N6) routing policies for a PDU session of interest; transmitting one or more policies and one or more (e.g., PCC) rules to an SMF; based on an AF request, determining one or more energy-unaware (e.g., N6) routing policies; updating one or more PCC rules corresponding with one or more routing policies; transmitting one or more updated rules with energy-unaware (e.g., N6) routing information to an SMF; receiving a message from an AF to indicate a compromise; receiving a negotiation message from an AF; transmitting one or more determined (e.g., N6) routing policies and one or more corresponding (e.g., PCC) rules to an SMF; transmitting a confirmation message to an AF; combinations of the same; or the like.

In certain representative embodiments, a PCF is configured to receive a notification message, e.g., from a UDR (e.g., using Nudr_DM_Notify), to indicate that a new AF request to influence traffic routing was authorized and/or stored. For example, the notification message includes AF request identification information and AF request input parameters. Also, for example, a PCF is configured to perform one or more steps of Option I, Option II, or Option III below.

For example, as Option I, a PCF is configured to determine one or more PDU sessions impacted by an AF request. Also, for example, a PCF is configured to determine, e.g., based on N6 routing information from the AF request, one or more new N6 routing policies and one or more updated PCC rules. Further, for example, a PCF is configured to determine to request and/or subscribe to energy cost information related to UP and N6 traffic routing information. In addition, for example, a PCF is configured to transmit a message to an EECF to obtain energy cost information related to one or more DNAIs included in N6 routing information. Moreover, for example, a PCF is configured to transmit a message to an EECF to obtain one or more parameters, e.g., at least one of energy cost information, an indication that energy monitoring thresholds have been met or exceeded, user equipment (UE) identification information, a PDU session identifier, one or more energy monitoring parameters, one or more reporting parameters, WTRU information, traffic identification information, combinations of the same, or the like. Furthermore, for example, a PCF is configured to receive, e.g., from an EECF, energy cost information associated with utilization of each DNAI in a list of one or more DNAIs. Additionally, for example, a PCF is configured to utilize energy cost information associated with one or more DNAIs to determine one or more new and/or updated energy-aware N6 routing policies. Still further, for example, a PCF is configured to update one or more PCC rules corresponding with one or more new and/or updated energy-aware N6 routing policies. Even further, for example, a PCF is configured to transmit one or more PCC rules including updated N6 routing information to an SMF.

For example, as Option II, a PCF is configured to be triggered, e.g., when receiving an AF request for N6 routing traffic influence, to obtain energy cost-related information related to one or more DNAIs of interest. Also, for example, a PCF is configured to transmit a request, e.g., to an EECF, to obtain energy cost information. Further, for example, a PCF is configured to receive, e.g., from the EECF, energy cost-related information associated with one or more DNAIs of interest. In addition, for example, a PCF is configured to utilize both initial N6 routing information of an AF request and energy cost information related to a list of one or more DNAIs, to determine to update N6 routing policies for a PDU session of interest (e.g., a list of candidate DNAIs includes only certain energy cost-efficient DNAIs). Moreover, for example, PCF is configured to transmit one or more new N6 routing policies and one or more corresponding PCC rules to an SMF.

For example, as Option III, a PCF is configured to determine, e.g., based on an AF request, one or more energy-unaware N6 routing policies and to update one or more corresponding PCC rules. Also, for example, a PCF is configured to transmit one or more updated PCC rules, e.g., with energy-unaware N6 routing information, to an SMF.

For example, after utilizing either Option I, Option II, or Option III, above, a PCF is configured to receive a message from an AF to indicate that a compromise between an AF request and one or more 5GC energy-related KPIs needs to take place. Also, for example, the message includes at least one of: a revised list of one or more DNAIs, e.g., a prioritized and/or sorted list of one or more DNAIs that are acceptable to an AF; a proposed and/or updated UP latency requirement; a delta value to represent an acceptable deviation value from an original UP latency requirement; a revised temporal validity condition; updated information in N6 routing information (e.g., setting an application relocation possibility to “yes” (e.g., when it was “no” in an original AF request)); an indication that WTRU IP address preservation is no longer necessary and/or is optional and/or is preferred; combinations of the same; or the like. Further, for example, a PCF is configured to receive a negotiation message from an AF. In addition, for example, a PCF is configured to determine, e.g., based on new information from an AF, a final N6 routing policy to be utilized. Moreover, for example, a PCF is configured to transmit one or more determined (e.g., after compromise) N6 routing policies with one or more corresponding PCC rules to an SMF. Furthermore, for example, a PCF is configured to transmit a confirmation message to an AF to confirm final N6 routing information, e.g., after negotiation and/or compromise between the PCF and the AF.

In certain representative embodiments, one or more AF traffic influence procedures are provided. For example, one or more procedures are provided to allow a 5GS to support processing and/or provisioning of one or more AF requests to influence traffic routing for a specific WTRU, for a specific PDU session, and/or for a traffic of interest.

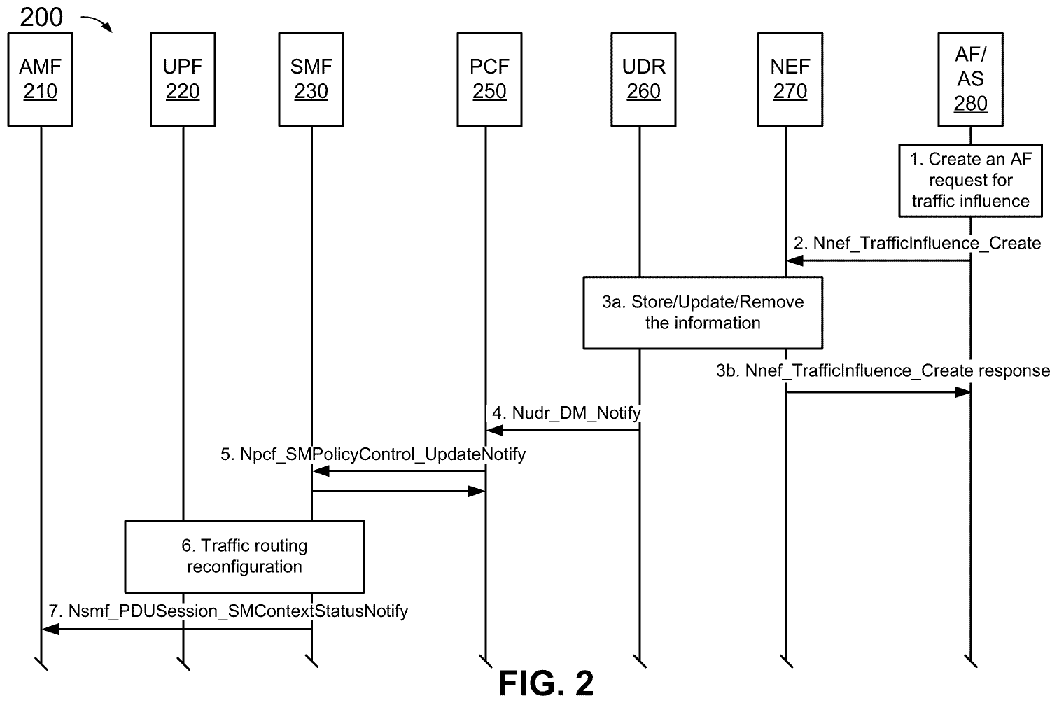

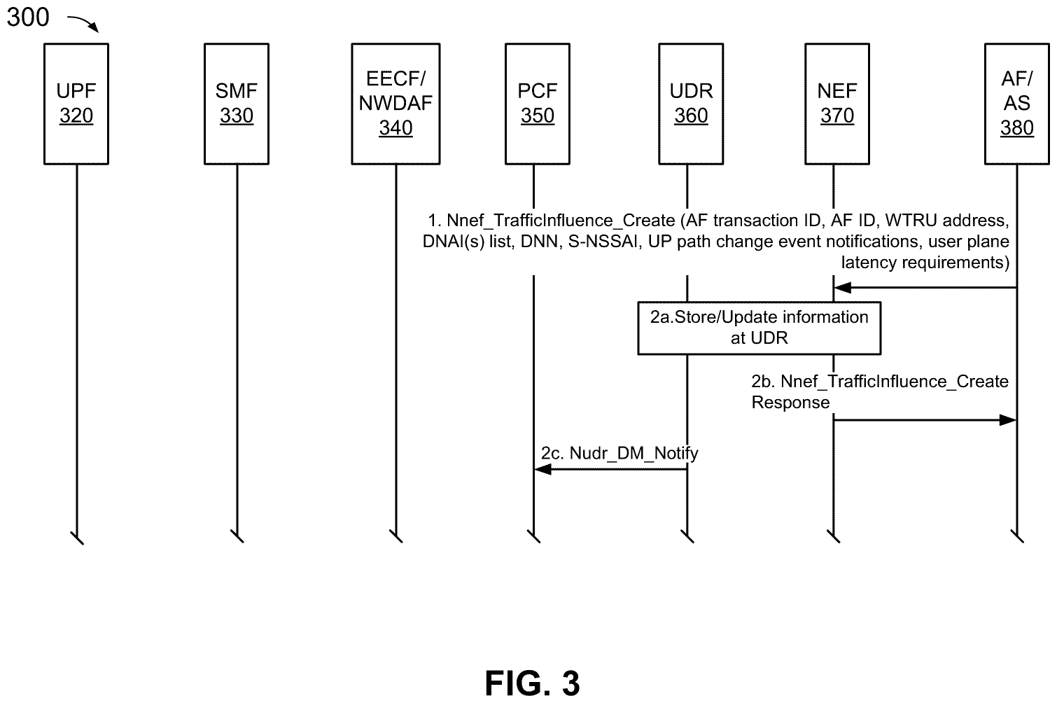

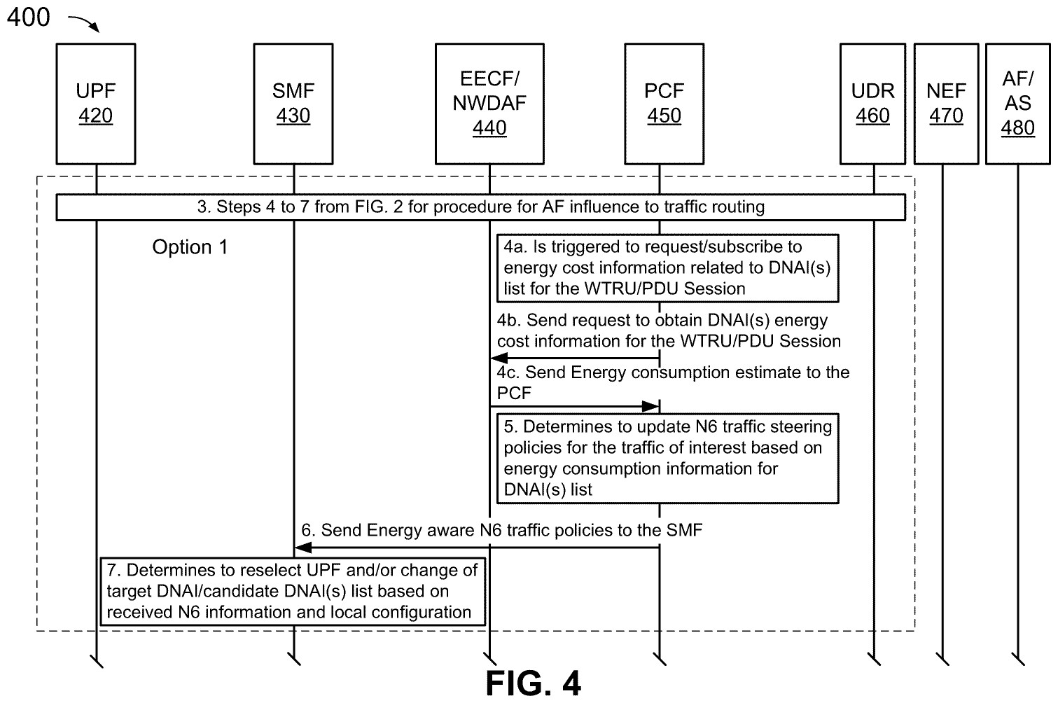

FIG. 2 is a sequence diagram illustrating an example of a procedure 200 to process an AF to influence traffic routing. For example, the procedure 200 involves at least one of AMF 210, UPF 220, SMF 230, PCF 250, UDR 260, NEF 270, AF and/or Application Server (AS) 280, combinations of the same, or the like. Also, for example, AF 280 creates (e.g., at Step 1) and transmits (e.g., at Step 2, e.g., utilizing Nnef_TrafficInfluence_Create) a request to a 5GS, e.g., using an application programming interface (API) of the NEF 270 to request to influence one or more traffic routing decisions. Further, for example, the AF 280 includes one or more WTRUs of interest and N6 traffic routing information. In addition, for example, traffic routing information includes at least one of information about one or more DNAIs, one or more temporal and/or spatial validity conditions, a possibility for application relocation, a WTRU IP address preservation indication, a subscription to one or more UP path change events and/or notifications, a UP latency requirement, combinations of the same, or the like.

For example, the NEF 270 receives (e.g., at Step 2) the request and/or information of the request, authorizes the request and/or information, and transmits the request and/or information to the UDR 260. Also, for example, the UDR 260 stores the request and/or information (e.g., at Step 3a). Further, for example, the NEF 270 transmits (e.g., at Step 3b) a response (e.g., Nnef_TrafficInfluence_Create response) to the AF 280. In addition, for example, a PCF (e.g., PCF 250) that serves a PDU session of interest has been subscribed to the UDR 260 to receive notification about an AF request change, e.g., when a new AF request is authorized. Moreover, for example, the UDR 260 transmits (e.g., at Step 4) a notification (e.g., Nudr_DM_Notify) to the PCF 250 including the new AF request.

For example, the PCF 250 utilizes the information associated with the AF request, e.g., including the N6 routing information, to determine the N6 routing policies for the PDU session that carries WTRU traffic. Also, for example, N6 policies are included in one or more PCC rules. Further, for example, N6 policies are updated and/or generated by the PCF 250. Further, for example, one or more N6 rules include a list of one or more (e.g., candidate) DNAIs and/or other parameters. In addition, for example, the PCF 250 transmits (e.g., at Step 5) one or more PCC rules including the new N6 routing policies to the SMF 230 serving the PDU session of the WTRU. Moreover, for example, the SMF 230 utilizes one or more PCC rules to configure (and/or reconfigure) the UPF 220 (e.g., at Step 6) with one or more N6 traffic routing policies. Furthermore, for example, the SMF 230 utilizes one or more PCC rules to setup one or more actions at the SMF 230, such as UP path change event reporting to the AF 280. Additionally, for example, the SMF 230 determines a target DNAI to serve a WTRU PDU session. Still further, for example, the SMF 230 determines to reconfigure one or more routes and/or performs reselection at the UPF 220 (e.g., at Step 6). Even further, for example, the SMF 230 notifies the AMF 210 of PDU session information and/or session management context status (e.g., at Step 7 utilizing Nsmf_PDUSession_SMContextStatusNotify). Yet further, for example, once traffic routing is reconfigured, the SMF 230 performs one or more PDU session modification procedures to update the WTRU with the new information.

In certain representative embodiments, an AF influences one or more traffic routing decisions, e.g., in a 5GS using NEF services, such as Nnef_TrafficInfluence service. For example, an AF provides to the 5GC (e.g., the PCF) at least one of a list of one or more DNAIs, one or more routing profile identifiers, N6 traffic routing information, related parameters, combinations of the same, or the like. Also, for example, one or more traffic influence routing related parameters include at least one of a UP latency requirement, a temporal validity condition, a spatial validity condition, combinations of the same, or the like. Further, for example, an AF requests that a network influence one or more routing decisions (e.g., as shown in FIG. 2 and described in related descriptions), but at least one of the network, a user device, or a subscriber is also energy efficient and/or energy aware. In addition, for example, the network overrides a previous UP path setup decision, which was based on the AF request. Moreover, for example, the network changes the UP path based on one or more energy requirements. Furthermore, for example, in a conflict scenario, a conflict, e.g., between an AF and a network, is resolved. As detailed in various embodiments and examples herein, one or more procedures are provided, e.g., between a network and an AF, to resolve one or more conflict scenarios.

In certain representative embodiments, an energy-aware 5GC refines and/or updates and/or overrides N6 routing information from an AF using energy cost-related information. For example, a 5GS, e.g., a PCF, utilizes energy-aware policies related to a WTRU and one or more PDU sessions of the WTRU. Also, for example, an AF influences traffic routing for a certain traffic of interest. Further, for example, a PCF utilizes energy consumption information related to an AF traffic influence request (e.g., related to one or more provided DNAIs in the AF request). In addition, for example, a PCF updates one or more processes in order to ensure that one or more energy related KPIs (e.g., energy consumption and/or energy efficiency related metrics for the 5GS and the UP path) are satisfied. Moreover, for example, a PCF updates one or more KPIs even though an AF that originated an AF traffic influence request does not have awareness, e.g., related to energy cost related to one or more routes and/or one or more DNAIs of interest.

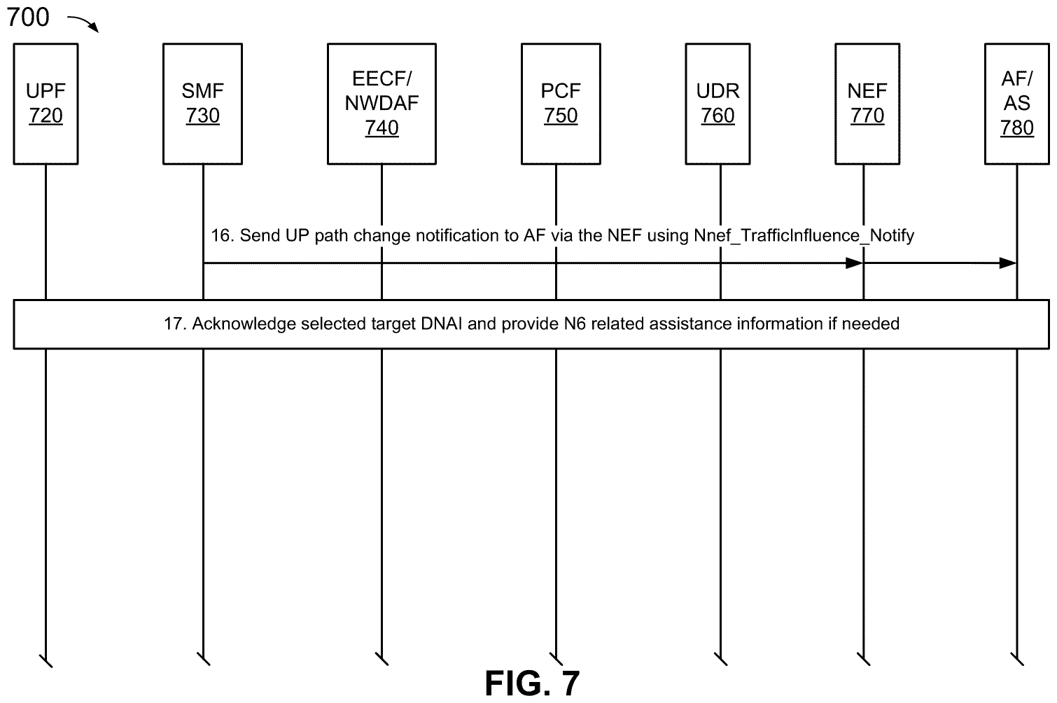

FIGS. 3-7 provide examples of procedures that utilize 5GS energy cost information to refine an AF influence request. FIG. 3 introduces initial steps of the procedure, FIGS. 4-6 present different options for intermediate steps of the procedure, and FIG. 7 depicts concluding steps of the procedure.

In certain representative embodiments, as shown in FIG. 3, a procedure 300 utilizes 5GS energy cost information to refine an (e.g., energy-unaware) AF influence request. For example, the procedure 300 involves at least one of UPF 320, SMF 330, EECF and/or Network Data Analytics Function (NWDAF) 340, PCF 350, UDR 360, NEF 370, AF and/or AS 380, combinations of the same, or the like.

For example, e.g., at Step 1, AF 380 transmits a request to the 5GS, e.g., to the NEF 370, to influence traffic routing. Also, for example, if the AF 380 is a trusted AF, then the AF 380 transmits the request directly to the PCF 350 (e.g., utilizing Npcf_PolicyAuthorization_Create service operation). Further, for example, if AF 380 is untrusted, then AF 380 transmits the request message to the PCF 350 utilizing the NEF 370. Further, for example, the AF 380 utilizes an API service operation of the NEF 370, e.g., Nnef_TrafficInfluence_Create. In addition, for example, the AF 380 includes an AF transaction identifier that refers to the request, as well as an AF identifier. Moreover, for example, a PDU session identifier is provided to identify, e.g., a PDU session. Furthermore, for example, when a network function, such as a PCF, requests information, a transaction identifier is sent and/or associated with the request. Additionally, for example, the transaction identifier allows a network function, e.g., an EECF, to indicate in the response to the PCF, the transaction identifier that identifies a message corresponding to the request.

For example, the traffic routing influence request includes at least one of an address and/or identifier of a WTRU of interest, a Data Network Name (DNN) and/or Single Network Slice Selection Assistance Information (S-NSSAI) that hosts traffic of interest, combinations of the same, or the like. Also, for example, the request includes an application ID and/or traffic filtering information to allow identification of traffic. Further, for example, the AF 380 includes a list of one or more DNAIs that are candidates that may be utilized for N6 traffic routing, as well as corresponding routing profile identifiers and/or N6 traffic routing information. In addition, for example, a list of one or more DNAIs does not consider energy cost related to the utilization of the one or more DNAIs for the WTRU and the PDU session, since the AF (e.g., AF request) is not energy aware. Moreover, for example, the AF 380 provides values DNAI1-DNAI5 in an initial DNAI list. Furthermore, for example, the AF 380 includes UP path change event notification, which allows the AF 380 to receive notifications from the SMF 330, related to UP path change events, such as change of target DNAI and/or UPF, or the like. Additionally, for example, the AF 380 includes UP latency requirements to indicate a maximum value latency between an anchor UPF (e.g., UPF 320) and the WTRU for the WTRU or PDU session of interest.

For example, at Step 2a, once the NEF 370 authorizes the AF request, the NEF 370 stores and/or updates the AF request information in the UDR 360.

For example, at Step 2b, the NEF 370 transmits a response message to the AF 380 to acknowledge the authorization of the AF request.

For example, at Step 2c, the PCF 350 (e.g., that serves the WTRU for the PDU session) has subscribed to modification of AF requests and receives a notification from the UDR 360 to indicate that data related to AF requests has changed, meaning a new AF request was authorized (and stored). Also, for example, the PCF 350 utilizes the information provided in the UDR 360 notification to identify the AF request and determine that the request is related to traffic routing influence. Further, for example, the AF request does not necessarily include energy-aware input parameters, such as DNAI(s), and the 5GS, including the PCF 350 are configured to take energy cost aspects into consideration to determine different policies.

As shown, for example, in FIGS. 4-6, three options are identified, depending on which network entity may leverage energy cost-related information related to the traffic influence request (e.g., DNAI(s)), (e.g., a PCF or SMF), and depending on when and how the network entity utilizes the information to refine and/or update traffic routing policies.

In certain representative embodiments, as shown in FIG. 4, a procedure 400 utilizes 5GS energy cost information to refine the (e.g., energy-unaware) AF influence request. For example, the procedure 400 involves at least one of UPF 420, SMF 430, EECF and/or NWDAF 440, PCF 450, UDR 460, NEF 470, AF and/or AS 480, combinations of the same, or the like.

For example, in Option 1, an AF request, e.g., to influence traffic routing in an energy-unaware way, is configured in a 5GS. Also, for example, at Step 3, Steps 4 to 7 of FIG. 2 occur. Further, for example, once the PCF 450 receives a notification from the UDR 460 related to the new AF request to influence traffic routing, the PCF 450 determines which one or more PDU sessions are impacted by the request. In addition, for example, the PCF 450 utilizes new N6 routing information from the request to update one or more impacted PCC rules that are associated with the considered traffic flow. Moreover, for example, the PCC rule includes the N6 routing policies that are derived from the AF N6 routing information.

For example, the N6 routing policy in the PCC rule may include the values DNAI1-DNAI4 in the rule (DNAI5 is not included, using PCF configuration). Also, for example, the PCF 450 transmits the PCC rule to the SMF 430. Further, for example, the SMF 430 utilizes the PCC rules to determine a target DNAI. In addition, for example, the SMF 430 performs UPF 420 reselection to be able to route the WTRU traffic appropriately. Moreover, for example, the SMF 430 configures N6 traffic routing policies at the UPF 420. Furthermore, for example, the SMF 430 determines to monitor a UP path change event related to the PDU session that carries the traffic flow. Additionally, for example, the PCF 450 is configured with one or more energy-aware policies, including one or more energy-aware routing policies.

For example, for a certain DNN value and S-NSSAI value, the PCF 450 determines that one or more energy saving procedures are to be performed. Also, for example, the PCF 450 determines for a PDU session carrying traffic related to a specific application identifier and/or a certain service type, that energy-related UP path adjustment is to be performed (e.g., for high energy consumption application traffic) and/or that energy cost monitoring is to be performed. Further, for example, the PCF 450 determines, e.g., based on network congestion information and/or network function (NF) load information, that energy-aware UP path optimization is to be performed. In addition, for example, the PCF 450 is triggered to request and/or subscribe to energy cost information obtained from the EECF 440.

For example, at Step 4a, once Step 3 is completed and/or successful, the PCF 450 determines to request and/or subscribe to energy cost information related to one or more DNAIs and/or other N6 routing related parameters for the WTRU and PDU session of interest.

For example, at Step 4b, the PCF 450 transmits a request and/or a subscription message to the EECF and/or NWDAF 440, to obtain energy cost information related to one or more DNAIs and related parameters. Also, for example, the PCF 450 includes the list of the one or more DNAIs, e.g., the list that was included in the AF traffic influence request, in the energy cost request to the EECF 440. Further, for example, the energy cost request includes the WTRU identifier and/or PDU session identifier. In addition, for example, the PCF 450 indicates that the information needed is an energy cost for the WTRU to utilize a specific DNAI and/or the incurred energy cost-related to the PDU session if this PDU session is moved to a specific DNAI. Moreover, for example, if the PCF 450 provides a list of DNAIs, then the EECF 440 determines energy cost information for each DNAI included in the PCF 450 message. Furthermore, for example, the energy cost indicates an energy consumption attribute. Additionally, for example, the PCF 450 obtains the average energy consumption of the PDU session in a certain time period, for a certain WTRU location, and/or using a specific DNAI. Still further, for example, the energy cost also includes an indication of an energy efficiency attribute. Even further, for example, the PCF 450 obtains the energy efficiency value and/or parameter, which are achieved when using a specific DNAI (e.g., for the PDU session of interest).

For example, if the PCF 450 request message is a subscription, then the PCF 450 includes one or more threshold values for the energy cost to indicate that the EECF 440 is to transmit a notification to the PCF 450 when the energy cost of a DNAI in a DNAI list exceeds a certain value. That is, for example, using the DNAI for the PDU session of the WTRU incurs an energy cost higher than the preferred and/or acceptable threshold. Also, for example, the PCF 450 indicates that the EECF 440 notifies the PCF 450 when certain energy costs of one or more DNAIs are below a certain value. That is, for example, the identified DNAI is a good candidate to utilize since it has an energy cost for the PDU session that is lower than the threshold value. Further, for example, once the EECF 440 receives the PCF 450 request, the EECF 440 determines to obtain analytics from the NWDAF 440, such as energy consumption and/or energy efficiency related analytics. In addition, for example, the EECF 440 determines to obtain other analytics such as DN performance and/or NF load analytics for the UPF 420 load. Moreover, for example, the PCF 450 includes one or more time intervals and/or location information for a time and a location required for the DNAI related energy cost information, which is included in the energy cost information request to the EECF 440. Furthermore, for example, the information is obtained from the AF traffic routing influence request, e.g., as one or more spatial validity and/or temporal validity conditions. Additionally, for example, the EECF 440 utilizes analytics information obtained from the NWDAF 440, e.g., together with other information, to determine the energy cost information to be provided to the PCF 450.

For example, at Step 4c, the EECF 440 transmits the requested DNAI related energy cost information to the PCF 450. Also, for example, energy cost information includes, e.g., for each DNAI in the list of one or more DNAIs from the PCF 450 request, at least one of: an indication of energy cost, an indication of energy consumption (e.g., at least one of average energy consumption (EC), peak EC, EC variations and/or variance, combinations of the same, or the like), an indication of energy efficiency (e.g., at least one of energy efficiency (EE) level and/or percentage, renewable energy usage level and/or percentage, combinations of the same, or the like), one or more other energy-related aspects, an indication of an energy-related service interruption (e.g., due to high energy load at serving UPF 420 or RAN node), combinations of the same, or the like. Further, for example, the EECF 440 provides such energy-related information for each DNAI. In addition, for example, if the PCF 450 provided a threshold in the request or subscription to the EECF 440, then the EECF 440 indicates a subset of DNAI(s) from the DNAI(s) list, and includes their energy cost value, and/or ranking between the DNAIs using the energy cost. Moreover, for example, the EECF 440, e.g., with the assistance of the NWDAF 440, includes information including timing as to when different UPFs serve the PDU session of the WTRU, e.g., using access point DNAI, and the EECF 440 evaluates, e.g., for each UPF 420 instance, the potential energy cost when using this UPF 420 instance to forward WTRU traffic to and/or from the DNAI of interest. Furthermore, for example, for different UPF 420 instances associated with a specific DNAI, the UP path has a different energy cost. Additionally, for example, the EECF 440 includes information related to different UPF 420 instances that are utilized for each DNAI and the corresponding energy cost.

For example, the EECF 440 determines an averaged energy cost value, e.g., which represents an energy cost value averaged over the different possible UPF 420 instances that can be associated with a specific DNAI. Also, for example, the EECF 440 provides average energy cost for each DNAI to the PCF 450. Further, for example, if the EECF 440 is provided with more than one time interval for the energy cost related to a DNAI (using one or more time validity conditions), then the EECF 440 provides for each time interval, the energy cost of each DNAI. In addition, for example, the EECF 440 provides a sorted list of DNAI(s) for each time interval, e.g., sorted using their energy cost. Moreover, for example, the EECF 440 provides the energy cost-related to a specific DNAI for a certain duration, e.g., when the PCF 450 provides the EECF 440 with a duration parameter. Furthermore, for example, the EECF 440 performs an average and/or an estimate of the energy cost considering all time intervals provided and determines an average energy cost that does not depend on the time intervals provided. Additionally, for example, the EECF 440 provides time interval averaged energy cost per DNAI to the PCF 450. Still further, for example, the EECF 440, based on the request from the PCF 450, and/or local configuration, determines to associate energy cost for using a certain DNAI with an energy class, e.g., using “high”, “medium”, and “low” energy cost. Even further, for example, the EECF 440 provides energy class related information to the PCF 450 instead of an exact energy cost value to the PCF 450. Yet further, for example, the EECF 440 provides the PCF 450 with the DNAI(s) that are associated with a certain energy class, e.g., a “low” energy cost class.

For example, at Step 5, the PCF 450 utilizes information related to energy cost associated with one or more DNAIs, e.g., provided by the EECF 440, to determine that N6 traffic routing policies are to be updated. Also, for example, the PCF 450 utilizes the N6 traffic routing policies included in the PCC rule of interest, e.g., that were provisioned to SMF 430 and UPF 420 at Step 3, and utilizes the energy cost information received from the EECF 440 at Step 4c, to determine to update the PCC rules, e.g., the N6 traffic routing policies related to the traffic of interest. Further, for example, the PCF 450 utilizes energy cost information related to each DNAI to determine and provide an updated list of DNAI(s) to the SMF 430. In addition, for example, from the list after Step 3, which includes DNAI1-DNAI4, the PCF 450 determines to include DNAI1 and DNAI2 as the updated DNAI(s) in a list (e.g., an energy-aware list). Moreover, for example, the PCF 450 includes in the updated list of DNAI(s) the DNAI for which the energy cost in below a certain threshold. Furthermore, for example, the PCF 450 includes in the updated DNAI(s) list the DNAI(s) that have low average energy consumption for the PDU session of interest, and/or the DNAI(s) that have a high enough energy efficiency related to the PDU session of interest.

For example, at Step 6, the PCF 450 transmits the updated PCC rule, e.g., including the new N6 traffic routing policies, to the SMF 430. Also, for example, the PCC rule includes a list of DNAI(s) that meet certain energy cost requirements as determined by the PCF 450, e.g., in addition to other requirements (e.g., other local policies at the PCF 450).

For example, at Step 7, the SMF 430 utilizes the PCC rule to configure the UPF 420 with the new N6 traffic routing policies. Also, for example, the SMF 430 utilizes the PCC rule to set up UP path change monitoring and event exposure to the AF 480, e.g., for the PDU session that carries the traffic of interest. Further, for example, the SMF 430 determines to change the target DNAI as well as the candidate DNAI(s) list, based on the received new N6 information and local configuration. In addition, for example, SMF 430 determines DNAI1 as the target DNAI when it has a lower energy cost than DNAI2. Moreover, for example, the SMF 430 determines to perform UPF 420 reselection for the PDU session of interest.

In Option 1, for example, the AF traffic influence original request was authorized and provisioned without any initial updates from the PCF 450. It was only after the PCF 450 determined to request and receive energy cost information related to the DNAI(s) that are included in the AF N6 routing information, and using that energy cost information to determine, for example, an updated DNAI(s) list (which includes DNAI(s) that consume lower energy or that are more energy efficient for the PDU session), that the PCF 450 determined to update the N6 routing policies and update the corresponding PCC rule. In Options 2 and 3, for example, the 5GS NFs, e.g., the PCF and SMF, determine to perform optimization related to energy cost for the DNAIs, e.g., before the original AF traffic influence request is fully provisioned.

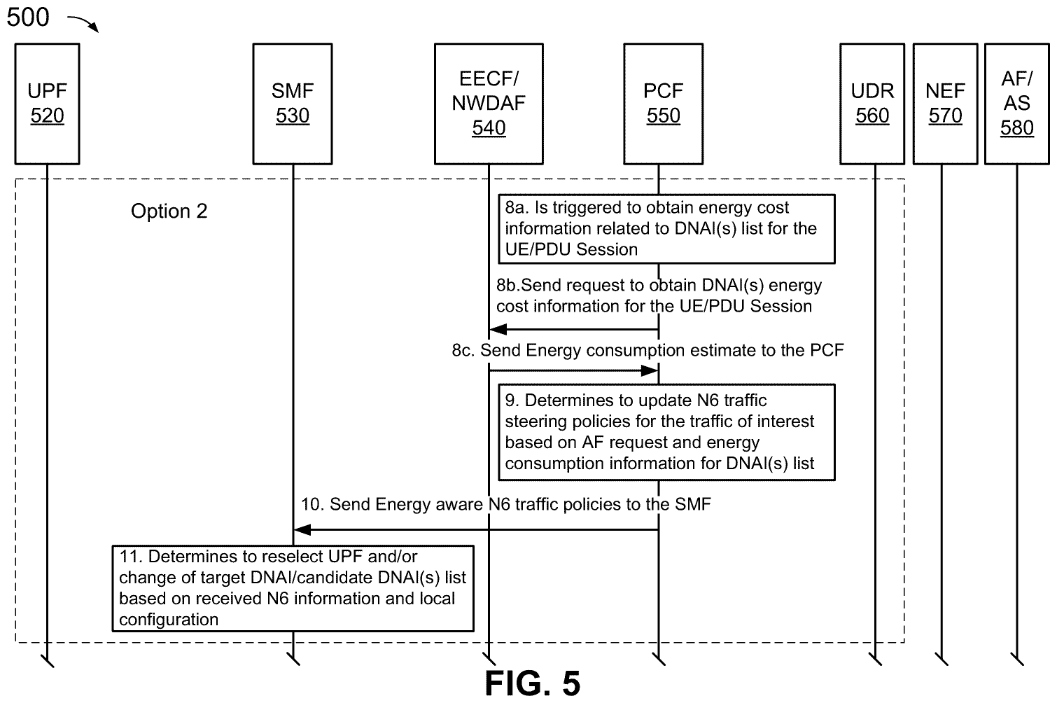

In certain representative embodiments, as shown in FIG. 5, a procedure 500 utilizes 5GS energy cost information to refine the (e.g., energy-unaware) AF influence request. For example, the procedure 500 involves at least one of UPF 520, SMF 530, EECF and/or NWDAF 540, PCF 550, UDR 560, NEF 570, AF and/or AS 580, combinations of the same, or the like.

In Option 2, for example, the PCF 550 obtains energy cost-related information and updates the N6 routing policies accordingly. Also, for example, at Step 8a, similar to Step 4a of Option 1, the PCF 550 is triggered to determine one or more energy cost aware N6 routing policies related to a traffic routing influence request received from the AF 580. Further, for example, the PCF 550 is triggered when receiving the AF request. In addition, for example, based on input parameters related to the AF request (e.g., DNN value, S-NSSAI value, application identifier, service type, or the like), a determination is made whether energy cost information and/or energy-aware N6 routing optimization is to be performed for the PDU session in question. Moreover, for example, the PCF 550 utilizes the initial DNAI(s) list, including DNAI1-DNAI5, to determine their energy cost information (which differs, in some instances, from Option 1, which, e.g., utilizes DNAI1-DNAI4 after policy decisions at Step 3). Furthermore, for example, the PCF 550 is triggered to obtain energy cost-related information.

For example, at Step 8b, the PCF 550 transmits a request and/or subscribe message to the EECF 540 to obtain such energy cost information related to the DNAI(s) included in the AF request, similar to Step 4b of Option 1. Also, for example, the content of the PCF 550 request and/or subscription in Step 8b is similar to that of Step 4b. Further, for example, once the energy cost-related information is determined, the EECF 540 transmits to the PCF 550 the requested energy cost-related information, e.g., at Step 8c, similar to Step 4c. In addition, for example, the content of this energy cost relation information is similar to that of Step 4c.

For example, at Step 9, the PCF 550 utilizes both the N6 routing information obtained from the AF 580 original AF traffic routing influence request and the energy cost information obtained from the EECF 540, to determine whether and how to update N6 routing policies for the PDU session and generate and/or update the corresponding PCC rule. Also, for example, the PCF 550 determines that DNAI1, DNAI2, and DNAI5 are included in the updated DNAI(s) list.

For example, at Step 10, the PCF 550 transmits the new N6 traffic routing policies included in the updated PCC rule to the SMF 530, similar to Step 6.

For example, at Step 11, the SMF 530 utilizes the PCC rule to configure the UPF with energy aware N6 traffic routing policy and determines to setup UP path change event exposure to the AF 580. Step 11 is similar to Step 7. Also, for example, since DNAI5 has lower energy cost than DNAI1 and DNAI2, the SMF 530 selects DNAI5 as a target DNAI.

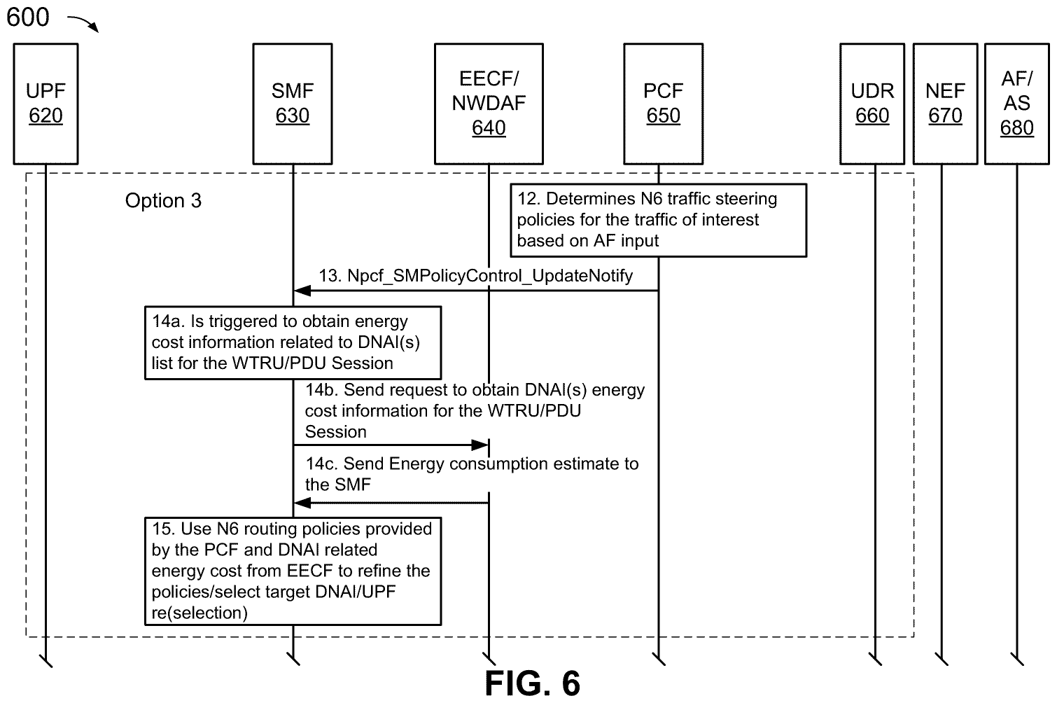

In certain representative embodiments, as shown in FIG. 6, a procedure 600 utilizes 5GS energy cost information to refine the (e.g., energy-unaware) AF influence request. For example, the procedure 600 involves at least one of UPF 620, SMF 630, EECF and/or NWDAF 640, PCF 650, UDR 660, NEF 670, AF and/or AS 680, combinations of the same, or the like.

In Option 3, for example, SMF 630 determines to obtain energy cost-related information from EECF 640. Also, for example, the SMF 630 determines one or more energy cost-efficient N6 routing policies.

For example, at Step 12, PCF 650 utilizes the AF request and related information, e.g., including the N6 traffic routing information, to determine one or more N6 routing policies for traffic of interest, and to generate and/or update one or more corresponding PCC rules. Also, for example, the one or more N6 routing policies are not energy-aware, since the PCF 650 only utilized local configuration and information provided by the AF request to determine these policies.

For example, at Step 13, PCF 650 transmits a PCC rule with one or more N6 routing policies for traffic flow to the SMF 630.

For example, at Step 14a, SMF 630 is triggered to refine and/or optimize one or more received N6 routing policies using energy cost-related information. Also, for example, the SMF 630 utilizes attributes (e.g., including an application identifier for an application of the traffic flow, a time window (e.g., time when there is high energy consumption expected, e.g., for the application of interest), a specific WTRU location, and other information) to determine that energy optimization, e.g., related to UP path and/or N6 routing, is to be performed.

For example, at Step 14b, SMF 630 transmits a request and/or subscription message to EECF 640 to obtain energy cost information related to DNAI(s) for a PDU session of interest. Also, for example, the SMF 630 utilizes the DNAIs included in the N6 routing policy provided by the PCF 650 at Step 13. Further, for example, one or more N6 routing policies include (similar to Step 3), DNAI1-DNAI4 (DNAI-5 is not included). In addition, for example, the SMF 630 provides input parameters to the EECF 640, e.g., including time information, such as one or more time windows, location information, DNN value, S-NSSAI value, combinations of the same, or the like. Moreover, for example, the SMF 630 determines one or more types of energy-related information to be provided. Furthermore, for example, the SMF 630 includes energy consumption and/or energy efficiency as a metric. Additionally, for example, similar to Step 8b and Step 4b, the SMF 630 include one or more threshold values related to energy cost. Still further, for example, the EECF 640 utilizes the one or more threshold values related to energy cost to provide and/or notify the SMF 630 when a related event takes place.

For example, at Step 14c, the EECF 640 derives, e.g., with the assistance of the NWDAF 640, energy cost-related information and determines to transmit information (e.g., in the form of a response and/or notification) to the SMF 630. Also, for example, Step 14c is similar to Step 8c and Step 4c.

For example, at Step 15, the SMF 630 utilizes N6 routing policies received earlier from the PCF 650 at Step 13 and/or the energy cost-related information received from the EECF 640 at Step 14c to configure the UPF 620 with refined N6 routing policies. Also, for example, the SMF 630 determines a target DNAI from the DNAI list obtained from the PCF 650. Further, for example, the SMF 630 selects the DNAI that is associated with the lowest energy cost as a target DNAI. In addition, for example, the SMF 630 determines that DNAI1 is the target DNAI. Moreover, for example, the SMF 630 determines to perform UPF 620 selection and/or reselection for a PDU session of interest. Furthermore, for example, the SMF 630 selects a UPF 620 from the candidate UPFs that are associated with the target DNAI (e.g., DNAI1) with the lowest energy cost. Additionally, for example, between a plurality of UPFs, i.e., UPF 1, UPF 2, and UPF 3 (not shown), UPF 2 has a lowest energy cost when associated with a target DNAI1.

In certain representative embodiments, as shown in FIG. 7, a procedure 700 includes 5GS energy cost information to refine the (e.g., energy-unaware) AF influence request. For example, the procedure 700 involves at least one of UPF 720, SMF 730, EECF and/or NWDAF 740, PCF 750, UDR 760, NEF 770, AF and/or AS 780, combinations of the same, or the like.

For example, at Step 16, SMF 730 transmits a UP path change notification to AF 780, e.g., via NEF 770, e.g., using Nnef_TrafficInfluence_Notify. Also, for example, at Step 17, between and among at least two of the UPF 720, the SMF 730, the EECF and/or NWDAF 740, the PCF 750, the UDR 760, the NEF 770, and the AF and/or AS 780, one or more selected target DNAIs are acknowledged and/or N6 related assistance information is provided, if needed.

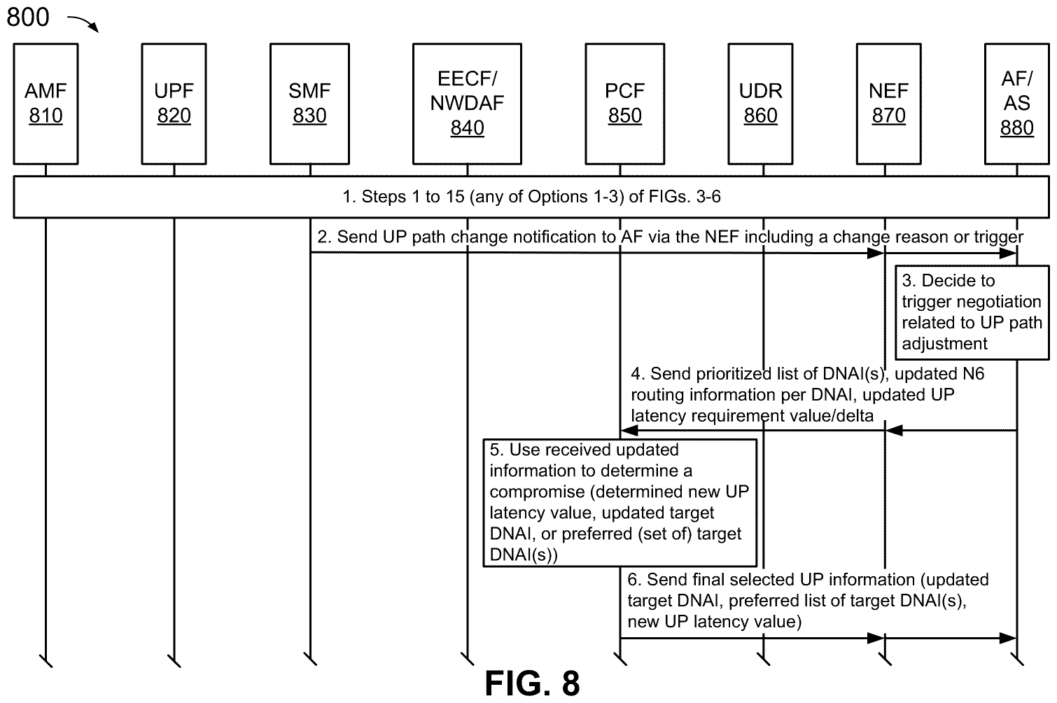

In certain representative embodiments, N6 traffic routing policies are provided. For example, negotiation between an energy-aware 5GC and an energy-unaware AF is provided. Also, for example, as shown in FIG. 8, a procedure 800 is provided in which an energy-unaware AF negotiates with an energy aware 5GS. Further, for example, N6 traffic routing related procedures are provided. In addition, for example, the procedure 800 involves at least one of UPF 820, SMF 830, EECF and/or NWDAF 840, PCF 850, UDR 860, NEF 870, AF and/or AS 880, combinations of the same, or the like.

For example, at Step 1, one or more of Steps 1 to 15 of FIGS. 3-6 are performed. Also, for example, AF 880 transmits a traffic influence request and provides N6 routing related information. Further, for example, at some point, depending on the utilized option, PCF 850 or SMF 830 is triggered to obtain energy cost-related information related to the AF request (e.g., DNAI(s) list). In addition, for example, one or more new N6 policies are generated and/or optimized using energy cost-related information. Moreover, SMF 830 and UPF 820 are configured to enforce one or more N6 routing policies.

For example, at Step 2, a 5GS, e.g., SMF 830 or PCF 850 transmits a notification message to AF 880 related to a UP path change event. Also, for example, if the AF 880 has subscribed to UP path change notifications from the SMF 830, then the SMF 830 transmits a notification to the AF 880 using the Nsmf_EventExposure_Notify service operation. Further, for example, the SMF 830 transmits the notification message to the AF 880 utilizing the NEF 870, and the NEF 870 utilizes the Nnef_TrafficInfluence_Notify service operation to transmit the notification to the AF 880. In addition, for example, the SMF 830 notifies the NEF 870 of the target DNAI or candidate DNAI(s) of the PDU session. Moreover, for example, the SMF 830 additionally includes a cause or reason value for the UP-path change. Furthermore, for example, the SMF 830 indicates that the UP path has changed or is determined to be changed due to energy-related constraints. Additionally, for example, the SMF 830 transmits a certain cause value C1 to the AF 880 utilizing the NEF 870. Still further, for example, the SMF 830 obtains, with the assistance of PCF 850 and EECF 840, information related to UP latency when the PDU session traffic is served by a certain UPF 820 and using a certain DNAI. Even further, for example, the SMF 830 obtains or determines an optimal value for UP latency, that the 5GS satisfies for the PDU session, such that the DNAI(s) that satisfy the optimal UP latency value also satisfy one or more energy cost KPIs from the 5GS (e.g., these candidate DNAI(s) may have been determined at Step 1 of FIG. 3).

For example, the SMF 830 includes in a notification message to AF 880, for each candidate DNAI(s) and/or for a target DNAI, an associated UP latency value that is satisfied by the 5GS while maintaining an energy cost efficiency of the UP path. Also, for example, the SMF 830 with the assistance of PCF 850, NWDAF and/or EECF 840, utilizes a temporal validity condition from initial N6 routing information provided by AF 880 (e.g., at Step 1), e.g., using Nnef_TrafficInfluence_Create request, to determine additional information. Further, for example, if a temporal validity condition is in a form of a time interval or includes multiple time intervals, or is in the form of a duration, then the 5GS determines that it is best or recommended that the time window or duration for which the N6 routing policies are valid or acceptable is a subset of the time interval or a smaller duration than what was initially provided by the AF 880. In addition, for example, if AF 880 indicated a duration value of 90 minutes for the N6 traffic routing information, then the 5GS determines that to satisfy energy cost-efficient N6 routing, the determined N6 routing information (e.g., using the determined energy cost-efficient target DNAI or candidate DNAI(s)) is set to a shorter duration of 45 minutes only. Moreover, for example, the AF 880 decide later on when the time duration completes to transmit a new traffic influence request to the 5GC. Furthermore, for example, the SMF 830 includes a revised temporal validity condition (e.g., revised time interval, revised duration, or the like) in the notification message to the AF 880. Additionally, for example, the 5GS determines if, e.g., multiple time intervals when the traffic routing is to be applied have different optimal DNAI(s) or an optimal target DNAI. Still further, for example, it is determined that from 1:00 pm to 1:45 pm, DNAI1 is the most suited energy cost-efficient DNAI, and that from 1:46 pm to 2:30 pm, DNAI3 is the most suitable DNAI in terms of energy cost efficiency. Even further, for example, if this is the case, then the SMF 830 includes a target DNAI value or candidate DNAI(s) for each time interval.

For example, at Step 3, once the AF 880 receives the notification message from the SMF 830 (e.g., utilizing the NEF 870), the AF 880 utilizes the UP path change notification and the cause of UP change (e.g., C1 for energy saving constraints) to trigger a negotiation process with the 5GC (e.g., via PCF 850, EECF 840, and SMF 830). Also, for example, an AF 880 that does not understand the cause value field, or the value of the cause being “energy-related constraints” or C1, disregards the cause field and treats the notification as it already does in the existing procedures (e.g., no negotiation takes place). Further, for example, the AF 880 understands the cause field associated with the UP path change event, without understanding that it deals with energy saving purposes and the like. In addition, for example, the AF 880 determines to further negotiate the provided routing information (e.g., from the SMF 830), if not satisfactory. Moreover, for example, the AF 880 utilizes information related to the notification received from the SMF 830 about UP path change, including a target DNAI or candidate DNAI(s) of the PDU session, cause value, or the like to determine and provide a prioritized and/or sorted list of DNAI(s) that the AF 880 wants and/or prefers to be utilized, and provides the AF 880 with a related requirement. Furthermore, for example, if initially in the original AF 880 request for traffic influence the AF 880 provided a UP latency requirement, then the AF 880 determines using the UP-path notification message and related information, to update or relax the UP-latency requirement. Additionally, for example, the AF 880 determines to provide a slightly higher value for the UP-latency requirement to allow the utilization of certain energy efficient DNAI(s) that were proposed by the SMF 830. Still further, for example, if the AF 880 received information about a maximum achievable UP latency value (e.g., for the target DNAI or for the candidate DNAI(s)) that the 5GS can satisfy while meeting energy saving related KPIs, the AF 880 utilizes this information to determine whether the proposed (e.g., achievable) UP latency that the 5GS provided for the target DNAI is acceptable or not.

For example, additionally, or alternatively, the AF 880 utilizes the 5GS proposed UP latency for each DNAI(s) to refine the list of DNAI(s). Also, for example, if DNAI1 has proposed UP latency value of 15 ms, DNAI2 has proposed UP latency value of 20 ms, and DNAI3 has proposed UP latency value of 12 ms, and if the original UP latency requirement provided by the AF 880 is 10 ms, then the AF 880 updates the DNAI(s) list by considering only DNAI1 and DNAI3, and not including DNAI2. Further, for example, if the SMF 830 notification message included a revised temporal validity condition, e.g., revised time interval(s) or revised duration, then the AF 880 determines whether it the revised time condition is satisfactory. In addition, for example, if the SMF 830 notification message further includes a different target DNAI or a candidate DNAI for different time intervals, then the AF 880 determines that a DNAI change is to take place in the future, which implies that the application is to be relocated and/or the PDU Session Anchor (PSA) UPF 820 is to be reelected. Moreover, for example, the AF 880 utilizes this determination to decide whether to set an “Application relocation possibility” field to yes (while it was “no” in the original request), and/or set an “WTRU IP address preservation indication” field to “no” or “preferred but not necessary”. Furthermore, for example, the AF 880 provides flexibility or a compromise in order to allow energy-related KPIs to be met (e.g., without directly being aware of such energy-related information), while also to allow traffic of the PDU session to be routed in the most acceptable way to the AF 880. Additionally, for example, the AF 880 determines to utilize one or more of the previously mentioned actions or strategies.

For example, at Step 4, the AF 880 transmits to the 5GS a message to include possibly modified N6 routing related information for the AF 880 traffic influence request of interest. Also, for example, the AF 880 utilizes an API of the NEF 870 (e.g., Nnef_TrafficInfluence_AppRelocationInfo or Nnef_TrafficInfluence_update) for this purpose. Further, for example, the AF 880 includes a prioritized list of DNAI(s) that are acceptable to be considered by the 5GS. In addition, for example, the AF 880 includes a proposed or updated UP latency requirement. Moreover, for example, the updated value includes an updated UP latency value or a value delta of the acceptable deviation from the original UP latency requirement that is acceptable to the AF 880. Furthermore, for example, the AF 880 includes updated N6 routing information such as an indication that a revised temporal validity condition (e.g., a time interval or duration) is acceptable and the value of such a parameter. Additionally, for example, the AF 880 indicates that application relocation is possible and/or WTRU IP address preservation is no longer needed (e.g., perhaps preferred or not needed at all for the current AF 880 traffic routing request). Still further, for example, the AF 880 includes a subset of DNAIs from the candidate DNAI(s) list(s) provided by the SMF 830, and an updated target DNAI or a confirmation that the proposed target DNAI is acceptable.

For example, at Step 5, once the 5GS, e.g., the PCF 850, receives the AF 880 message with the updated information, the PCF 850 utilizes the received updated information to determine the final N6 routing policy to be utilized. Also, for example, the PCF 850, e.g., with the assistance of the SMF 830, determines the updated time duration, the updated target DNAI, the updated list of candidates DNAI(s), the indication that application relocation is possible, and/or that WTRU IP address preservation is not necessary.

For example, at Step 6, the SMF 830 transmits a message to the AF 880 to confirm the final traffic routing information that was selected, including a target DNAI, a new UP latency value, a preferred list of targets DNAI(s), or the like. Also, for example, for a negotiation interaction between the AF 880 and the 5GC, Steps 4-6 may take place between the AF 880 and PCF 850, between the AF 880 and SMF 830, or between the AF 880, PCF 850, and SMF 830. Further, for example, Steps 2-6 described herein may also take place at any time after the AF 880 traffic-influenced procedures described in herein are completed.

In certain representative embodiments, an NEF determines a common DNAI for a set of WTRUs for an AF request, e.g., taking energy cost information into consideration. For example, an AF transmits a traffic influence request that targets not only an individual WTRU, but a group of WTRUs. Also, for example, the AF indicates that a common DNAI is to be selected for the set of WTRUs accessing the application identified in the AF request. Further, for example, if the AF does not provide a common DNAI in the AF request to the 5GS, the 5GC determines the common DNAI. In addition, for example, the common DNAI is determined by the NEF, which stores the common DNAI in the UDR as part of the information related to the AF influence request. Moreover, for example, the NEF is configured to determine and select a common DNAI that not only suits the AF request, but also satisfies energy cost-related goals.

For example, Step 1 of FIG. 2 is executed. Also, for example, the AF transmits an AF traffic routing influence request for a set of WTRUs. Further, for example, the AF request includes DNAI list(s) and other N6 routing information. In addition, for example, the AF indicates that a common DNAI is to be selected.

For example, the NEF forwards the AF request to the PCFs that are serving the WTRUs for the PDU sessions. Also, for example, the PCF utilizes the AF information to determine N6 routing policies and PCC rules to transmit to the SMFs serving the WTRU. Further, for example, the SMF determines that a common DNAI is needed but is not available (e.g., the AF did not provide a common DNAI value but only an indication that a common DNAI is to be selected).

For example, in a first scenario, in an Option A, the SMF determines with the assistance of the PCF and EECF, target DNAI(s) or candidate DNAI(s) that satisfy network energy cost related to each PDU session of interest for each WTRU in the set of WTRUs. Also, for example, the SMFs provide the energy cost-efficient or compliant candidate DNAI(s) for each WTRU of interest. Further, for example, the NEF utilizes the energy compliant DNAI(s) provided by the SMF to determine and select a common DNAI for the set of WTRUs.

For example, in an Option B, the SMF determines candidate DNAI(s) that are not necessarily energy efficient (e.g., without the assistance of the EECF, NWDAF, and PCF). Also, for example, the SMFs transmit the candidate DNAI(s) to the NEF and a request to obtain a common DNAI. Further, for example, the SMF utilizes Nsmf_TrafficCorrelation_notify service operation. In addition, for example, the NEF is triggered to obtain energy cost-related information related to the DNAI(s) related to each WTRU and PDU session of interest from the EECF. Moreover, for example, the energy cost associated with the WTRUs is a WTRU-specific energy cost, as described herein. Furthermore, for example, for a group of WTRUs, when a common DNAI is to be determined, the energy efficient DNAIs for each WTRU are not the energy efficient common DNAI(s) for the group of WTRUs. Additionally, for example, determining an energy efficient common DNAI may be at least one of: based on an average among all groups of WTRUs to find a most efficient common DNAI for the group, a common DNAI that provides a maximum energy efficiency for all WTRUs, utilizing weights between WTRUs to identify a most suitable energy efficient common DNAI, or the like. Still further, for example, once the NEF receives the energy cost-related information, the NEF utilizes this information together with the information provided by the SMFs to determine and select a common DNAI for the set of WTRUs.

For example, in a second scenario, in an Option C, as soon as the NEF receives the AF request for traffic influence (e.g., indicating selection of a common DNAI), the NEF is triggered to obtain energy cost information related to the PDU sessions and set of WTRUs for the candidate DNAI(s) list(s) that were received from the AF. Also, for example, once the NEF receives the energy cost-related information, the NEF utilizes this information to determine a common DNAI for the WTRUs. Further, for example, the NEF informs the SMF, PCF and AF of the determined and/or selected (e.g., energy cost-efficient) common DNAI.

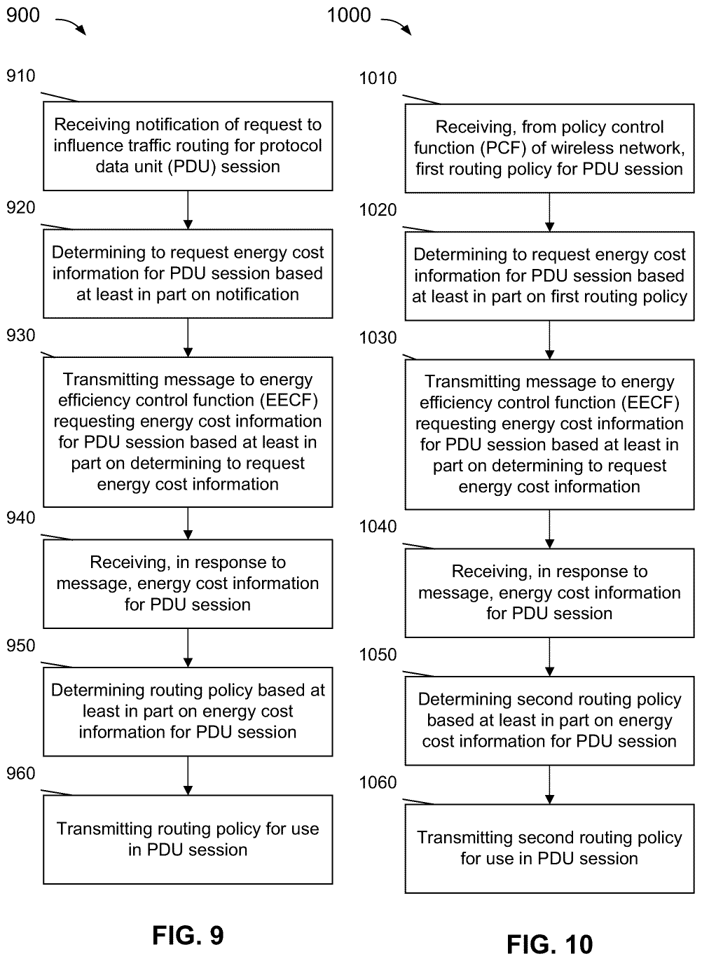

In certain representative embodiments, as shown in FIG. 9, a process 900 is performed by a policy control function (PCF) (e.g., PCF 450 or PCF 550) of a wireless network in connection with routing traffic in a protocol data unit (PDU) session. For example, the process 900 includes receiving 910 a notification of a request to influence traffic routing for the PDU session (e.g., Steps 1-4 of FIG. 2; or Steps 1-2c of FIG. 3). Also, for example, the process 900 includes determining 920 to request energy cost information for the PDU session based at least in part on the notification (e.g., Step 4a, FIG. 4; or Step 8a, FIG. 5). Further, for example, the process 900 includes transmitting 930 a message to an energy efficiency control function (EECF) (e.g., EECF 440 or EECF 540) requesting the energy cost information for the PDU session based at least in part on determining to request the energy cost information (e.g., Step 4b, FIG. 4; or Step 8b, FIG. 5). In addition, for example, the process 900 includes receiving 940, in response to the message, the energy cost information for the PDU session (e.g., Step 4c, FIG. 4; or Step 8c, FIG. 5). Moreover, for example, the process 900 includes determining 950 a routing policy based at least in part on the energy cost information for the PDU session (e.g., Step 5, FIG. 4; or Step 9, FIG. 5). Furthermore, for example, the process 900 includes transmitting 960 the routing policy for use in the PDU session (e.g., Step 6, FIG. 4; or Step 10, FIG. 5).

For example, the routing policy is a second routing policy, and the process 900 further includes receiving N6 routing information for the PDU session. Also, for example, the process 900 further includes identifying the PDU session based at least in part on the request. Further, for example, the process 900 further includes determining a first routing policy for the PDU session based at least in part on the N6 routing information. In addition, for example, the process 900 further includes transmitting the first routing policy for use in the PDU session. Moreover, for example, the second routing policy is used in place of the first routing policy.

For example, the energy cost information for the PDU session comprises respective energy cost information for each of a plurality of data network access identifiers (DNAIs) associated with the PDU session.

For example, the routing policy comprises energy aware N6 routing policies, e.g., included in a policy and charging control rule. Also, for example, the transmitting 960 the routing policy for use in the PDU session comprises transmitting the routing policy to a session management function (SMF) (e.g., SMF 430 or SMF 530) of the wireless network. Further, for example, the determining 950 the routing policy comprises determining the routing policy further based at least in part on initial N6 routing information.

For example, the process 900 further includes receiving from the EECF at least one of energy cost information, an indication that energy monitoring thresholds have been met or exceeded, user equipment (UE) identification information, a PDU session identifier, one or more energy monitoring parameters, one or more reporting parameters, WTRU information, traffic identification information, combinations of the same, or the like.

For example, the process 900 further includes receiving a negotiation message from an AF (e.g., AF 480 or AF 580) of the wireless network. Also, for example, the determining 950 the routing policy is further based on the negotiation message. Further, for example, the negotiation message comprises information indicative of at least one of: a list of data network access identifiers (DNAIs), a user plane (UP) latency requirement, a delta requirement from an original UP latency requirement, a deviation parameter from an original UP requirement, a temporal validity condition, updated N6 routing information, a preference for whether user equipment (UE) IP address preservation is to be used, or a possibility for application relocation.

In certain representative embodiments, as shown in FIG. 10, a process 1000 is performed by a session management function (SMF) (e.g., SMF 630) of a wireless network in connection with routing traffic in a protocol data unit (PDU) session. For example, the process 1000 includes receiving 1010, for a policy control function (PCF) of a wireless network, a first routing policy for the PDU session (e.g., Steps 12-13, FIG. 6). Also, for example, the process 1000 includes determining 1020 to request energy cost information for the PDU session based at least in part on the notification (e.g., Step 14a, FIG. 6). Further, for example, the process 1000 includes transmitting 1030 a message to an energy efficiency control function (EECF) (e.g., EECF 640) requesting the energy cost information for the PDU session based at least in part on determining to request the energy cost information (e.g., Step 14b, FIG. 6). In addition, for example, the process 1000 includes receiving 1040, in response to the message, the energy cost information for the PDU session (e.g., Step 14c, FIG. 6). Moreover, for example, the process 1000 includes determining 1050 a second routing policy based at least in part on the energy cost information for the PDU session (e.g., Step 15, FIG. 6). Furthermore, for example, the process 1000 includes transmitting 1060 the second routing policy for use in the PDU session.

For example, the energy cost information for the PDU session comprises respective energy cost information for each of a plurality of data network access identifiers (DNAIs) associated with the PDU session.

For example, the second routing policy comprises energy aware N6 routing policies, e.g., included in a policy and charging control rule. Also, for example, the transmitting 1060 the second routing policy for use in the PDU session comprises transmitting the second routing policy to a user plane function (UPF) (e.g., UPF 620) of the wireless network. Further, for example, the determining 1050 the second routing policy comprises determining the second routing policy further based at least in part on initial N6 routing information.

For example, the process 1000 further includes receiving from the EECF at least one of energy cost information, an indication that energy monitoring thresholds have been met or exceeded, user equipment (UE) identification information, a PDU session identifier, one or more energy monitoring parameters, one or more reporting parameters, WTRU information, traffic identification information, combinations of the same, or the like.

For example, the process 1000 further includes receiving a negotiation message from an AF of the wireless network. Also, for example, the determining 1050 the second routing policy is further based on the negotiation message. Further, for example, the negotiation message comprises information indicative of at least one of: a list of data network access identifiers (DNAIs), a user plane (UP) latency requirement, a delta requirement from an original UP latency requirement, a deviation parameter from an original UP requirement, a temporal validity condition, updated N6 routing information, a preference for whether user equipment (UE) IP address preservation is to be used, or a possibility for application relocation.

In certain representative embodiments, a wireless network system comprising circuitry is provided for implementing a policy control function (PCF) (e.g., PCF 450 or PCF 550) and an efficiency control function (EECF) (e.g., EECF 440 or EECF 540). For example, the circuitry is to receive a notification of a request to influence traffic routing for a protocol data unit (PDU) session (e.g., Steps 1-4 of FIG. 2; or Steps 1-2c of FIG. 3). Also, for example, the circuitry is to determine to request energy cost information for the PDU session based at least in part on the notification (e.g., Step 4a, FIG. 4; or Step 8a, FIG. 5). Further, for example, the circuitry is to transmit a message to the EECF requesting the energy cost information for the PDU session based at least in part on determining to request the energy cost information (e.g., Step 4b, FIG. 4; or Step 8b, FIG. 5). In addition, for example, the circuitry is to receive, in response to the message, the energy cost information for the PDU session (e.g., Step 4c, FIG. 4; or Step 8c, FIG. 5). Moreover, for example, the circuitry is to determine a routing policy based at least in part on the energy cost information for the PDU session (e.g., Step 5, FIG. 4; or Step 9, FIG. 5). Furthermore, for example, the circuitry is to transmit the routing policy for use in the PDU session (e.g., Step 6, FIG. 4; or Step 10, FIG. 5).

For example, the routing policy is a second routing policy, and the circuitry is further to receive N6 routing information for the PDU session. Also, for example, the circuitry is further to identify the PDU session based at least in part on the request. Further, for example, the circuitry is further to determine a first routing policy for the PDU session based at least in part on the N6 routing information. In addition, for example, the circuitry is further to transmit the first routing policy for use in the PDU session. Moreover, for example, the second routing policy is used in place of the first routing policy.

For example, the energy cost information for the PDU session comprises respective energy cost information for each of a plurality of data network access identifiers (DNAIs) associated with the PDU session.

For example, the circuitry is further for implementing an AF. Also, for example, the circuitry is further to receive a negotiation message from the AF. Further, for example, the determining the routing policy is further based on the negotiation message. In addition, for example, the negotiation message comprises information indicative of at least one of: a list of data network access identifiers (DNAIs), a user plane (UP) latency requirement, a delta requirement from an original UP latency requirement, a deviation parameter from an original UP requirement, a temporal validity condition, updated N6 routing information, a preference for whether user equipment (UE) IP address preservation is to be used, or a possibility for application relocation.

Throughout the specification the phrases “in response to” and “based on” shall be understood to have a broad meaning unless context requires otherwise. For example, “in response to” can refer to a step that is in direct or indirect response to a prior step, and “based on”can refer to a step that is based at least in part on a prior step.

Each of the contents of the following references is incorporated by reference herein in their entireties: (1) 3GPP TR 23.700-66 Study on Energy Efficiency and Energy Saving, Release 19, V1.0.0 (June 10, 2024); (2) 3GPP TS 23.501, System architecture for the 5G System (5GS), Stage 2, V19.0.0 (June 26, 2024); (3) 3GPP TS 23.502, Procedures for the 5G System (5GS), Stage 2, V19.0.0 (June 26, 2024); and (4) 3GPP TS 23.503, Policy and charging control framework for the 5G System (5GS), Stage 2, V19.0.0 (June 26, 2024).

Although features and elements are provided above in particular combinations, one of ordinary skill in the art will appreciate that each feature or element can be utilized alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶ 6, 35 U.S. C. § 112(f) or means-plus-function claim format, and any claim without the terms “means for” is not so intended.

What is claimed:

1. A method performed by a policy control function (PCF) of a wireless network in connection with routing traffic in a protocol data unit (PDU) session, the method comprising:
receiving a notification of a request to influence traffic routing for the PDU session;
determining to request energy cost information for the PDU session based at least in part on the notification;
transmitting a message to an energy efficiency control function (EECF) requesting the energy cost information for the PDU session based at least in part on determining to request the energy cost information;
receiving, in response to the message, the energy cost information for the PDU session;
determining a routing policy based at least in part on the energy cost information for the PDU session; and
transmitting the routing policy for use in the PDU session.

2. The method of claim 1, wherein the routing policy is a second routing policy, the method further comprising:
receiving N6 routing information for the PDU session;
identifying the PDU session based at least in part on the request;
determining a first routing policy for the PDU session based at least in part on the N6 routing information; and
transmitting the first routing policy for use in the PDU session, wherein the second routing policy is used in place of the first routing policy.

3. The method of claim 1, wherein the energy cost information for the PDU session comprises respective energy cost information for each of a plurality of data network access identifiers (DNAIs) associated with the PDU session.

4. The method of claim 1, wherein the routing policy comprises energy aware N6 routing policies included in a policy and charging control rule, and wherein the transmitting the routing policy for use in the PDU session comprises transmitting the routing policy to a session management function (SMF) of the wireless network.

5. The method of claim 4, wherein the determining the routing policy comprises determining the routing policy further based at least in part on initial N6 routing information.

6. The method of claim 1, further comprising receiving from the EECF at least one of energy cost information, an indication that energy monitoring thresholds have been met or exceeded, user equipment (UE) identification information, or a PDU session identifier.

7. The method of claim 1, further comprising:
receiving a negotiation message from an application function (AF) of the wireless network, wherein determining the routing policy is further based on the negotiation message.

8. The method of claim 7, wherein the negotiation message comprises information indicative of at least one of: a list of data network access identifiers (DNAIs), a user plane (UP) latency requirement, a delta requirement from an original UP latency requirement, a deviation parameter from an original UP requirement, a temporal validity condition, updated N6 routing information, a preference for whether user equipment (UE) IP address preservation is to be used, or a possibility for application relocation.

9. A method performed by a session management function (SMF) of a wireless network in connection with routing traffic in a protocol data unit (PDU) session, the method comprising:
receiving, from a policy control function (PCF) of the wireless network, a first routing policy for the PDU session,
determining to request energy cost information for the PDU session based at least in part on the first routing policy;
transmitting a message to an energy efficiency control function (EECF) requesting the energy cost information for the PDU session based at least in part on determining to request the energy cost information;
receiving, in response to the message, the energy cost information for the PDU session;
determining a second routing policy based at least in part on the energy cost information for the PDU session; and
transmitting the second routing policy for use in the PDU session.

10. The method of claim 9, wherein the energy cost information for the PDU session comprises respective energy cost information for each of a plurality of data network access identifiers (DNAIs) associated with the PDU session.

11. The method of claim 9, wherein the second routing policy comprises energy aware N6 routing policies included in a policy and charging control rule, and wherein the transmitting the second routing policy for use in the PDU session comprises transmitting the second routing policy to a user plane function (UPF) of the wireless network.

12. The method of claim 11, wherein the determining the second routing policy comprises determining the second routing policy further based at least in part on initial N6 routing information.

13. The method of claim 9, further comprising receiving from the EECF at least one of energy cost information, an indication that energy monitoring thresholds have been met or exceeded, user equipment (UE) identification information, or a PDU session identifier.

14. The method of claim 9, further comprising:
receiving a negotiation message from an application function (AF) of the wireless network, wherein determining the second routing policy is further based on the negotiation message.

15. The method of claim 14, wherein the negotiation message comprises information indicative of at least one of: a list of data network access identifiers (DNAIs), a user plane (UP) latency requirement, a delta requirement from an original UP latency requirement, a deviation parameter from an original UP requirement, a temporal validity condition, updated N6 routing information, a preference for whether user equipment (UE) IP address preservation is to be used, or a possibility for application relocation.

16. A wireless network system comprising circuitry for implementing a policy control function (PCF) and an efficiency control function (EECF), the circuitry to:
receive a notification of a request to influence traffic routing for a protocol data unit (PDU) session;
determine to request energy cost information for the PDU session based at least in part on the notification;
transmit a message to the EECF requesting the energy cost information for the PDU session based at least in part on determining to request the energy cost information;
receive, in response to the message, the energy cost information for the PDU session;
determine a routing policy based at least in part on the energy cost information for the PDU session; and
transmit the routing policy for use in the PDU session.

17. The system of claim 16, wherein the routing policy is a second routing policy, the circuitry further to:
receive N6 routing information for the PDU session;
identify the PDU session based at least in part on the request;
determine a first routing policy for the PDU session based at least in part on the N6 routing information; and
transmit the first routing policy for use in the PDU session, wherein the second routing policy is used in place of the first routing policy.

18. The system of claim 16, wherein the energy cost information for the PDU session comprises respective energy cost information for each of a plurality of data network access identifiers (DNAIs) associated with the PDU session.

19. The system of claim 16, wherein the circuitry is further for implementing an application function (AF), wherein the circuitry is further to receive a negotiation message from the AF, and wherein the determining the routing policy is further based on the negotiation message.

20. The system of claim 19, wherein the negotiation message comprises information indicative of at least one of: a list of data network access identifiers (DNAIs), a user plane (UP) latency requirement, a delta requirement from an original UP latency requirement, a deviation parameter from an original UP requirement, a temporal validity condition, updated N6 routing information, a preference for whether user equipment (UE) IP address preservation is to be used, or a possibility for application relocation.
